(19) United States
(12) Patent Application Publication
(10) Pub. No.: US 2015/0095520 A1
(43) Pub. Date: Apr. 2, 2015

(54) SEMICONDUCTOR MEMORY APPARATUS AND DATA INPUT AND OUTPUT METHOD THEREOF

(71) Applicant: SK hynix Inc., Icheon-si (KR)

(72) Inventor: Seung Wook KWACK, Icheon-si (KR)

(73) Assignee: SK hynix Inc., Icheon-si (KR)

(21) Appl. No.: 14/148,220

(22) Filed: Jan. 6, 2014

(30) Foreign Application Priority Data
Sep. 30, 2013 (KR) 10-2013-0116283

(51) Int. Cl. G06F 3/06

(52) U.S. Cl. CPC G06F 3/0661; G06F 3/0614; G06F 3/0671; G06F 2003/0697
USPC 710/14; 710/74

(57) ABSTRACT

A semiconductor memory apparatus includes an input data bus inversion unit, a data input line, a termination unit, a data recovery unit and a memory bank. The input data bus inversion unit determines whether or not to invert a plurality of input data based on an operation mode signal and the plurality of input data and generates a plurality of conversion data. The data input line transmits the plurality of conversion data. The termination unit terminates the data input line in response to the operation mode signal. The data recovery unit receives the plurality of conversion data and generates a plurality of storage data. The memory bank configured to store the plurality of storage data.

### CROSS-REFERENCES TO RELATED APPLICATION

The present application claims priority under 35 U.S.C. §119(a) to Korean application number 10-2013-0116283, filed on Sep. 30, 2013, in the Korean Intellectual Property Office, which is incorporated herein by reference in its entirety as set forth in full.

### BACKGROUND

1. Technical Field

Various embodiments relate to a semiconductor memory apparatus, and more particularly, to a semiconductor memory apparatus that adopts data bus inversion.

2. Related Art

As the data processing speeds of a central processing unit (CPU) and a graphic processing unit (GPU) are gradually increased, semiconductor memory apparatuses capable of operating at a high frequency are needed inevitably. However, in the semiconductor memory apparatuses operating at a high frequency band, the performances of the semiconductor memory apparatuses are likely to deteriorate due to noise of data. In order to solve this problem, the strength of a data driver has been increased or design has been conducted in consideration of a clock margin. Nevertheless, problems are still caused in that noise is generated and misoperation occurs due to an increase in the number of data switching times in the high frequency band.

Accordingly, a data bus inversion (hereinafter, referred to as “DBI”) scheme capable of minimizing the number of data switching times has been proposed in the art. In the DBI scheme, what number of data bits among a predetermined number of data bits, for example, 8 data bits induce current flow in transistors of a data output buffer is determined and if the number of data bits having a logic value that may induce the current flow is large, the number of data bits are inverted so that current consumption may be reduced.

FIG. 1 is a block diagram schematically illustrating the configuration of a conventional semiconductor memory apparatus.

A conventional semiconductor memory apparatus 10 includes a data bus inversion determination unit (hereinafter, referred to as a “DBI determination unit”) 11 and a data output unit 12. The DBI determination unit 11 is enabled by receiving a mode signal ‘mode’ that is enabled from a mode register set. The DBI determination unit 11 receives data GIO<0:7> that are transmitted from data input/output lines and generates a determination signal ‘flag’ for determining whether to invert data, depending upon the logic levels of the data GIO<0:7>. The data output unit 12 has a plurality of data output drivers DQ1 through DQ8. The data output unit 12 receives the data GIO<0:7> transmitted from the data input/output lines and the determination signal ‘flag’ and determines whether to output the data by inverting it or passing the data through as is, that is, simply transmitting the data. If the mode signal ‘mode’ is enabled, the determination signal ‘flag’ is transferred to a chipset that is connected with the semiconductor memory apparatus 10. Therefore, even though inverted output data are outputted, the chipset may recognize that the data having levels opposite to those of the inverted output data are precise data.

Nonetheless, in the conventional semiconductor memory apparatus, since whether to output the data by inverting or non-inverting (i.e. transmitting) them is determined and data may be inverted only in the data output unit 12, a problem is caused in that current consumption is substantial due to toggling of the data input/output lines for transmitting data. Also, in the conventional art, due to an interfacing problem that is likely to occur between the semiconductor memory apparatus and the chipset, the inversion operation may be performed only in a DBI mode by receiving the mode signal ‘mode’ that is generated from the mode register set and cannot be performed in a normal mode.

### SUMMARY

A semiconductor memory apparatus that performs a data bus inversion function in data input and output operations and a data input and output method thereof are described herein.

In an embodiment of the present invention, a semiconductor memory apparatus includes: an input data bus inversion unit configured to determine whether or not to invert a plurality of input data based on an operation mode signal and the plurality of input data and to generate a plurality of conversion data; a data input line configured to transmit the plurality of conversion data; a termination unit configured to terminate the data input line in response to the operation mode signal; a data recovery unit configured to receive the plurality of conversion data and generate a plurality of storage data; and a memory bank configured to store the plurality of storage data.

In an embodiment of the present invention, a semiconductor memory apparatus includes: an input data bus inversion unit configured to determine whether or not to invert a plurality of input data based on an operation mode signal and the plurality of input data and to generate a plurality of first conversion data; a first data recovery unit configured to invert or pass through the plurality of first conversion data and generate a plurality of storage data; a memory bank configured to store the plurality of storage data; an output data bus inversion unit configured to determine whether or not to invert the plurality of storage data outputted from the memory bank based on the operation mode signal and the plurality of storage data outputted from the memory bank and to generate a plurality of second conversion data; a second data recovery unit configured to receive the plurality of second conversion data and generate a plurality of output data; and a data transmission line configured to transmit the plurality of first conversion data and the plurality of second conversion data.

In an embodiment of the present invention, a semiconductor memory apparatus includes: an data bus inversion unit configured to determine whether or not to invert a plurality of received data based on an operation mode signal and the plurality of received data and to generate a plurality of conversion data; a data transmission line configured to transmit the plurality of conversion data; and a termination unit configured to terminate the data transmission line in response to the operation mode signal.

### BRIEF DESCRIPTION OF THE DRAWINGS

Features, aspects and embodiments are described in conjunction with the attached drawings, in which:

FIG. 1 is a block diagram schematically illustrating the configuration of a conventional semiconductor memory apparatus;

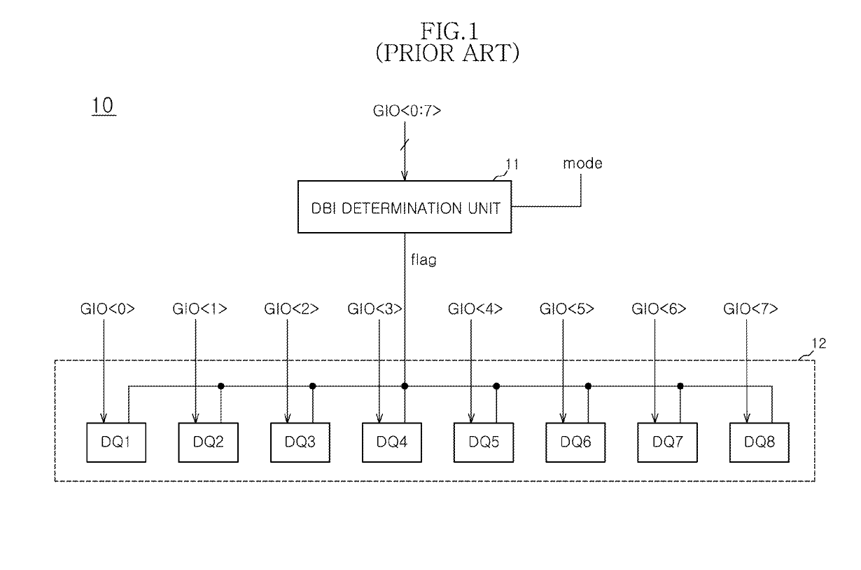

FIG. 2 is a block diagram schematically illustrating the configuration of a semiconductor memory apparatus in accordance with an embodiment of the present invention;

FIG. 3 is a diagram illustrating the input and output flow of data when the semiconductor memory apparatus operates in a first mode in accordance with the embodiments of the present invention;

FIG. 4 is a diagram illustrating the input and output flow of data when the semiconductor memory apparatus operates in a second mode in accordance with the embodiments of the present invention; and

FIG. 5 is a diagram schematically illustrating the layout of the semiconductor memory apparatus in accordance with the embodiments of the present invention.

### DETAILED DESCRIPTION

Hereinafter, a semiconductor memory apparatus and a data input and output method thereof according to the present invention will be described below with reference to the accompanying drawings through various examples of embodiments.

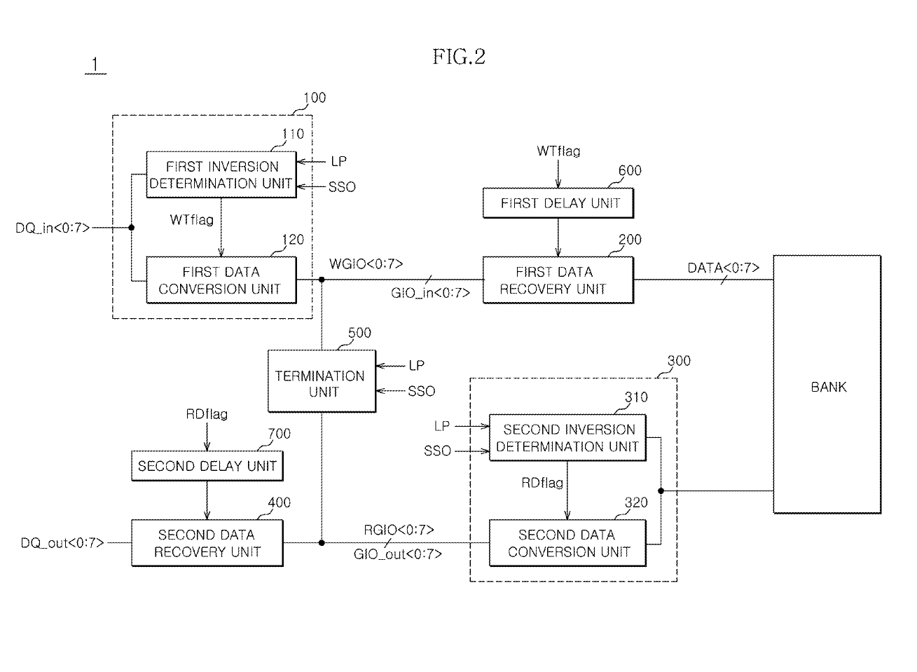

Referring to FIG. 2, a semiconductor memory apparatus 1 includes an input data bus inversion unit 100, data input lines WGIO<0:7>, a first data recovery unit 200, a memory bank BANK, an output data bus inversion unit 300, data output lines RGIO<0:7>, a second data recovery unit 400 and a termination unit 500.

When the data input operation of the semiconductor memory apparatus 1 is performed, a plurality of input data DQ_in<0:7> are inputted to the semiconductor memory apparatus 1 from outside through data pads (not shown). The input data bus inversion unit 100 is configured to receive the plurality of input data DQ_in<0:7> and determine whether or not to invert the plurality of input data DQ_in<0:7> based on an operation mode signals LP and SSO and the plurality of input data DQ_in<0:7>. The input data bus inversion unit 100 discriminates the levels of the plurality of input data DQ_in<0:7> in response to the operation mode signals LP and SSO and generates a plurality of first conversion data GIO_in<0:7> by inverting or passing through (i.e., transmitting) the plurality of input data DQ_in<0:7> depending upon a discrimination result. The operation mode signals LP and SSO may include a first and second operation mode signals and the first and second operation mode signals LP and SSO may be signals indicating a first and second operation modes, respectively. The first operation mode may mean an operation mode where a data is transmitted by terminating a data transmission line and the second operation mode may mean an operation mode where a data is transmitted without termination of the data transmission line. The first and second operation mode signals LP and SSO may be generated by a mode register circuit in the semiconductor memory apparatus 1.

The input data bus inversion unit 100 determines whether or not to invert the plurality of input data DQ_in<0:7> in different ways to each other in response to the first and second operation mode signals LP and SSO. The input data bus inversion unit 100 may determine whether or not to invert the plurality of input data DQ_in<0:7> in response to the first operation mode signal LP when a majority of the plurality of input data DQ_in<0:7> have a first level. The input data bus inversion unit 100 may determine whether or not to invert the plurality of input data DQ_in<0:7> in response to the second operation mode signal SSO by comparing logic levels of the plurality of input data DQ_in<0:7>, which are currently inputted, with logic levels of the plurality of input data DQ_in<0:7>, which are previously inputted.

For example, when the semiconductor memory apparatus 1 operates in the first mode, the input data bus inversion unit 100 in response to the first operation mode signal LP inverts the plurality of input data DQ_in<0:7>, that is, data on a plurality of data lines and generates the plurality of first conversion data GIO_in<0:7> when a majority of the plurality of input data DQ_in<0:7> have the first level and passes through the plurality of input data DQ_in<0:7> and generates the plurality of first conversion data GIO_in<0:7> when a majority of the plurality of input data DQ_in<0:7> have a second level. As used herein, the terminology “first level” may refer to, for example, a logic low level and the terminology “second level” may refer to a logic high level, while not being limited to such. The first and second levels may vary depending upon the default level of the data input lines. Namely, if the data input lines are fixed to a logic low level and toggle when transmitting data of a logic high level, the first level may be a logic high level and the second level may be a logic low level. The logic level that produces the greatest current flow is used in making the decision of whether to invert. In other words, if the number of data bits having a logic level that will induce current flow is large, these data bits are inverted so that current consumption may be reduced.

When the semiconductor memory apparatus 1 operates in the second mode, the input data bus inversion unit 100 in response to the second operation mode signal SSO inverts the plurality of input data DQ_in<0:7>, that is, data on a plurality of data lines and generates the plurality of first conversion data GIO_in<0:7> when a majority of logic levels of the plurality of input data DQ_in<0:7>, which are currently inputted, are different from logic levels of the plurality of input data DQ_in<0:7>, which are previously inputted. The input data bus inversion unit 100 in response to the second operation mode signal SSO passes through the plurality of input data DQ_in<0:7> and generates the plurality of first conversion data GIO_in<0:7> when a majority of logic levels of the plurality of input data DQ_in<0:7>, which are currently inputted, are the same as logic levels of the plurality of input data DQ_in<0:7>, which are previously inputted.

The data input lines WGIO<0:7> serve as transmission paths of the plurality of first conversion data GIO_in<0:7>. The data input lines WGIO<0:7> connect the data pads that receive the input data DQ_in<0:7> inputted from the outside and the memory bank BANK in which the data are to be stored. In particular, in an embodiment of the present invention, the data input lines WGIO<0:7> connect the input data bus inversion unit 100 and the first data recovery unit 200. Accordingly, the plurality of first conversion data GIO_in<0:7> may be transmitted to the first data recovery unit 200 through the data input lines WGIO<0:7>.

The first data recovery unit 200 is configured to receive the plurality of first conversion data GIO_in<0:7> and generate a plurality of storage data DATA<0:7>. The first data recovery unit 200 inverts or passes through the first conversion data GIO_in<0:7> depending upon whether the input data bus inversion unit 100 inverts or passes through the input data DQ_in<0:7>. In other words, the first data recovery unit 200 receives the first conversion data GIO_in<0:7> and generates the storage data DATA<0:7> that have substantially the same logic levels as the input data DQ_in<0:7>. Because some data errors may still occur due to, for example, noise infiltrating the data lines, some of the bits may not be transmitted to the memory bank BANK correctly. Therefore, the data logic levels are substantially the same as the input data logic levels in that there may be slight errors contained in the transmitted data. Further, the voltage levels corresponding to the logic levels may not be identical in different physical sections of the semiconductor apparatus. Therefore, although the voltages may differ, the data will still be interpreted as corresponding to the correct logic levels and therefore the logic levels are substantially the same.

The memory bank BANK includes a plurality of memory cells and stores the plurality of storage data DATA<0:7> that are generated by the first data recovery unit 200.

Through the configuration as mentioned above, the semiconductor memory apparatus 1 discriminates the logic levels of the input data DQ_in<0:7> when the input data DQ_in<0:7> are inputted from the outside and transmits the input data DQ_in<0:7> to the data input lines WGIO<0:7> by inverting or passing through the input data DQ_in<0:7>. As a consequence, current consumption that is likely to occur in the data input lines WGIO<0:7> due to toggling may be reduced by the various embodiments. Also, the storage data DATA<0:7> that have substantially the same levels as the levels of the input data DQ_in<0:7> may be generated by the first data recovery unit 200 and may be stored in the memory bank BANK.

When the data output operation of the semiconductor memory apparatus 1 is performed, the plurality of storage data DATA<0:7> that are stored in the memory bank BANK are outputted from the memory bank BANK. The output data bus inversion unit 300 is configured to receive the plurality of storage data DATA<0:7> that are outputted from the memory bank BANK and determine whether or not to invert the plurality of storage data DATA<0:7> based on the operation mode signals LP and SSO and the plurality of storage data DATA<0:7>. The output data bus inversion unit 300 discriminates the levels of the plurality of storage data DATA<0:7> in response to the operation mode signals LP and SSO and generates a plurality of second conversion data GIO_out<0:7> by inverting or passing through (i.e., transmitting) the plurality of storage data DATA<0:7> depending upon a discrimination result.

The output data bus inversion unit 300, likewise the input data bus inversion unit 100, determines whether or not to invert the plurality of storage data DATA<0:7> in different ways to each other in response to the first and second operation mode signals LP and SSO. The output data bus inversion unit 300 may determine whether or not to invert the plurality of storage data DATA<0:7> in response to the first operation mode signal LP when a majority of the plurality of storage data DATA<0:7> have the first level. The output data bus inversion unit 300 may determine whether or not to invert the plurality of storage data DATA<0:7> in response to the second operation mode signal SSO by comparing the plurality of storage data DATA<0:7>, which are currently outputted, with the plurality of storage data DATA<0:7>, which are previously outputted.

For example, when the semiconductor memory apparatus 1 operates in the first mode, the output data bus inversion unit 300 in response to the first operation mode signal LP inverts the plurality of storage data DATA<0:7> and generates the plurality of second conversion data GIO_out<0:7> when a majority of the plurality of storage data DATA<0:7> have the first level and passes through the plurality of storage data DATA<0:7> and generates the plurality of second conversion data GIO_out<0:7> when a majority of the plurality of storage data DATA<0:7> have the second level.

When the semiconductor memory apparatus 1 operates in the second mode, the output data bus inversion unit 300 in response to the second operation mode signal SSO inverts the plurality of storage data DATA<0:7> and generates the plurality of second conversion data GIO_out<0:7> when a majority of logic levels of the plurality of storage data DATA<0:7>, which are currently outputted, are different from logic levels of the plurality of storage data DATA<0:7>, which are previously outputted. The output data bus inversion unit 300 in response to the second operation mode signal SSO passes through the plurality of storage data DATA<0:7> and generates the plurality of second conversion data GIO_out<0:7> when a majority of logic levels of the plurality of storage data DATA<0:7>, which are currently outputted, are the same as the plurality of storage data DATA<0:7>, which are previously outputted.

The data output lines RGIO<0:7> serve as transmission paths of the plurality of second conversion data GIO_out<0:7>. The data output lines RGIO<0:7> connect the memory bank BANK in which the storage data DATA<0:7> are stored and the data pads that output output data DQ_out<0:7>. In particular, in an embodiment of the present invention, the data output lines RGIO<0:7> connect the output data bus inversion unit 300 and the second data recovery unit 400. While the data input lines WGIO<0:7> and the data output lines RGIO<0:7> are differently named for the sake of convenience in explanation, the data input lines WGIO<0:7> and the data output lines RGIO<0:7> actually constitute the same data transmission lines that simultaneously perform input and output operations, in the semiconductor memory apparatus 1. Therefore, in this sense, the data input and data output lines, that is, the data transmission lines, provide operative coupling of the input data bus inversion unit 100 to the first data recovery unit 200, which is further operatively coupled to the memory bank BANK. Furthermore, the memory bank BANK is operatively coupled to the output data bus inversion unit 300, which is further operatively coupled to the second data recovery unit 400. The terminology “operatively coupled” as used herein thus refers to coupling that enables operational and/or functional communication and relationships there-between and may include any intervening items necessary to enable such communication such as, for example, the data communication buses or any other necessary intervening items that one of ordinary skill would understand to be present. Also, it is to be understood that other intervening items may be present between “operatively coupled” items even though such other intervening items are not necessary to the functional communication facilitated by the operative coupling. For example, a data communication bus may provide data to several items along a pathway along which two or more items are operatively coupled, etc. Such operative coupling is shown generally in the figures described herein.

The second data recovery unit 400 is configured to receive the plurality of second conversion data GIO_out<0:7> and generate the plurality of output data DQ_out<0:7>. The second data recovery unit 400 inverts or passes through the second conversion data GIO_out<0:7> depending upon whether the output data bus inversion unit 300 generates the second conversion data GIO_out<0:7> by inverting the storage data DATA<0:7> or generates the second conversion data GIO_out<0:7> by passing through the storage data DATA<0:7>. Accordingly, the second data recovery unit 400 generates the output data DQ_out<0:7> that have substantially the same logic levels as the storage data DATA<0:7>. As a result, all of the input data DQ_in<0:7>, the storage data DATA<0:7> and the output data DQ_out<0:7> have substantially the same logic levels.

Through the configuration as mentioned above, even though the second conversion data GIO_out<0:7> that are generated as the storage data DATA<0:7> are inverted by the output data bus inversion unit 300 are transmitted through the data output lines RGIO<0:7>, the output data DQ_out<0:7> that have substantially the same logic levels as the storage data DATA<0:7> may be outputted through the data pads due to the presence of the second data recovery unit 400. Also, since the output data bus inversion unit 300 discriminates the logic levels of the storage data DATA<0:7> and outputs the second conversion data GIO_out<0:7> to the data output lines RGIO<0:7> by inverting or passing through the storage data DATA<0:7>, current consumption that is likely to occur in the data output lines RGIO<0:7> may be reduced.

The termination unit 500 may terminate the data transmission lines, that is, the data input lines WGIO<0:7> and the data output lines RGIO<0:7> in response to the operation mode signals LP and SSO. The termination unit 500 may terminate the data transmission lines WGIO<0:7> and RGIO<0:7> to the first level in response to the first operation mode signal LP. The termination unit 500 may not terminate the data transmission lines WGIO<0:7> and RGIO<0:7> in response to the second operation mode signal SSO.

In a case where the termination unit 500 terminates the data transmission lines WGIO<0:7> and RGIO<0:7> to the first level in response to the first operation mode signal LP, data of the first level in the plurality of input data DQ_in<0:7> and the plurality of storage data DATA<0:7> may be transmitted through the data transmission lines WGIO<0:7> and RGIO<0:7> without current consumption and data of the second level in the plurality of input data DQ_in<0:7> and the plurality of storage data DATA<0:7> may be transmitted by driving the data transmission lines WGIO<0:7> and RGIO<0:7> to the second level. Therefore, the input data bus inversion unit 100 and the output data bus inversion unit 300 may minimize current consumption for driving the data transmission lines WGIO<0:7> and RGIO<0:7> to the second level by inverting the input data DQ_in<0:7> and the storage data DATA<0:7> and transmitting the inverted input data DQ_in<0:7> and the inverted storage data DATA<0:7> through the data transmission lines WGIO<0:7> and RGIO<0:7> when a majority of the plurality of input data DQ_in<0:7> and the plurality of storage data DATA<0:7> have the first level under the first operation mode.

In a case where the termination unit 500 does not terminate the data transmission lines WGIO<0:7> and RGIO<0:7> in response to the second operation mode signal SSO, the plurality of input data DQ_in<0:7> and the plurality of storage data DATA<0:7> may be transmitted by driving the data input lines WGIO<0:7> and the data output lines RGIO<0:7> to the first and second level, respectively. Therefore a logic level of data that is currently inputted or outputted should be compared with a logic level of data that is previously inputted or outputted in order to minimize current consumption for driving the data transmission lines WGIO<0:7> and RGIO<0:7>. In order that a data of the second level may be currently transmitted through the data transmission lines WGIO<0:7> and RGIO<0:7>, through which a data of the first level has been previously transmitted, current consumption may occur for driving the data transmission lines WGIO<0:7> and RGIO<0:7> to the second level. In order that a data of the first level may be currently transmitted through the data transmission lines WGIO<0:7> and RGIO<0:7>, through which a data of the first level has been previously transmitted, there is no need to drive the data transmission lines WGIO<0:7> and RGIO<0:7> to another level. Therefore, a logic level of data that is currently inputted or outputted should be compared with a logic level of data that is previously inputted or outputted in order to minimize a number of switching for driving the data transmission lines WGIO<0:7> and RGIO<0:7>. Therefore, the input data bus inversion unit 100 and the output data bus inversion unit 300 under the second operation mode invert the plurality of input data DQ_in<0:7> and storage data DATA<0:7> and transmit the inverted input data DQ_in<0:7> and storage data DATA<0:7> through the data transmission lines WGIO<0:7> and RGIO<0:7> thereby minimizing the number of switching for driving the data transmission lines WGIO<0:7> and RGIO<0:7> when a majority of logic levels of the plurality of input data DQ_in<0:7> and storage data DATA<0:7>, which are currently inputted or outputted, are different from logic levels of the plurality of input data DQ_in<0:7> and storage data DATA<0:7>, which are previously inputted or outputted.

Referring to FIG. 2, the input data bus inversion unit 100 includes a first inversion determination unit 110 and a first data conversion unit 120 operatively coupled to the first inversion determination unit 110. The first inversion determination unit 110 is configured to receive the operation mode signals LP and SSO and the plurality of input data DQ_in<0:7> and generate a first inversion signal WTflag depending upon the logic levels of the plurality of input data DQ_in<0:7>. The first inversion determination unit 110 in response to the first operation mode signal LP enables the first inversion signal WTflag when the majority of the plurality of input data DQ_in<0:7> have the first level and disables the first inversion signal WTflag when the majority of the plurality of input data DQ_in<0:7> have the second level. Also, the first inversion determination unit 110 in response to the second operation mode signal SSO enables the first inversion signal WTflag when a majority of logic levels of the plurality of input data DQ_in<0:7>, which are currently inputted, are different from logic levels of the plurality of input data DQ_in<0:7>, which are previously inputted, and disables the first inversion signal WTflag when a majority of logic levels of the plurality of input data DQ_in<0:7>, which are currently inputted, are the same as the plurality of input data DQ_in<0:7>, which are previously inputted.

The first data conversion unit 120 is configured to invert or pass through the plurality of input data DQ_in<0:7> in response to the first inversion signal WTflag. The first data conversion unit 120 inverts the plurality of input data DQ_in<0:7> and generates the plurality of first conversion data GIO_in<0:7> when the first inversion signal WTflag is enabled and passes through the plurality of input data DQ_in<0:7> and generates the plurality of first conversion data GIO_in<0:7> when the first inversion signal WTflag is disabled.

The first data recovery unit 200 receives the first inversion signal WTflag. The first data recovery unit 200 inverts or passes through the first conversion data GIO_in<0:7> in response to the first inversion signal WTflag. The first data recovery unit 200 inverts the first conversion data GIO_in<0:7> and generates the storage data DATA<0:7> when the first inversion signal WTflag is enabled. The first data recovery unit 200 passes through the first conversion data GIO_in<0:7> and generates the storage data DATA<0:7> when the first inversion signal WTflag is disabled.

When the first inversion signal WTflag is enabled, the input data bus inversion unit 100 inverts the input data DQ_in<0:7> and generates the first conversion data GIO_in<0:7> and the first data recovery unit 200 inverts the first conversion data GIO_in<0:7> and generates the storage data DATA<0:7>. Conversely, when the first inversion signal WTflag is disabled, the input data bus inversion unit 100 passes through the input data DQ_in<0:7> and generates the first conversion data GIO_in<0:7> and the first data recovery unit 200 passes through the first conversion data GIO_in<0:7> and generates the storage data DATA<0:7>. Thus, the storage data DATA<0:7> may be data that have substantially the same levels as the input data DQ_in<0:7>.

The semiconductor memory apparatus 1 may further include a first delay unit 600, operatively coupled to the first data recovery unit 200, for delaying the first inversion signal WTflag. The first delay unit 600 is configured to delay the first inversion signal WTflag and provide a resultant signal to the first data recovery unit 200. Since the first conversion data GIO_in<0:7> are transmitted through the data input lines WGIO<0:7>, a time interval exists from when the first inversion determination unit 110 generates the first inversion signal WTflag to when the first data recovery unit 200 performs the inversion operation. Therefore, the first delay unit 600 is provided to compensate for the time interval.

Referring to FIG. 2, the output data bus inversion unit 300 includes a second inversion determination unit 310 and a second data conversion unit 320 that is operatively coupled to the second inversion determination unit 310. The second inversion determination unit 310 is configured to receive the operation mode signals LP and SSO and the plurality of storage data DATA<0:7> that are outputted from the memory bank BANK and generate a second inversion signal RDflag depending upon the levels of the plurality of storage data DATA<0:7>. Similar to the first inversion determination unit 110, the second inversion determination unit 310 in response to the first operation mode signal LP enables the second inversion signal RDflag when the majority of the plurality of storage data DATA<0:7> have the first level and disables the second inversion signal RDflag when the majority of the plurality of storage data DATA<0:7> have the second level. Also, the second inversion determination unit 310 in response to the second operation mode signal SSO enables the second inversion signal RDflag when a majority of logic levels of the plurality of storage data DATA<0:7>, which are currently inputted, are different from logic levels of the plurality of storage data DATA<0:7>, which are previously inputted, and disables the second inversion signal RDflag when a majority of logic levels of the plurality of storage data DATA<0:7>, which are currently inputted, are the same as the plurality of storage data DATA<0:7>, which are previously inputted.

The second data conversion unit 320 is configured to invert or pass through the plurality of storage data DATA<0:7> in response to the second inversion signal RDflag. The second data conversion unit 320 inverts the plurality of storage data DATA<0:7> and generates the plurality of second conversion data GIO_out<0:7> when the second inversion signal RDflag is enabled and passes through the plurality of storage data DATA<0:7> and generates the plurality of second conversion data GIO_out<0:7> when the second inversion signal RDflag is disabled.

The second data recovery unit 400 receives the second inversion signal RDflag. The second data recovery unit 400 inverts or passes through the second conversion data GIO_out<0:7> in response to the second inversion signal RDflag and generates the plurality of output data DQ_out<0:7>. The second data recovery unit 400 inverts the second conversion data GIO_out<0:7> and generates the output data DQ_out<0:7> when the second inversion signal RDflag is enabled. The second data recovery unit 400 passes through the second conversion data GIO_out<0:7> and generates the output data DQ_out<0:7> when the second inversion signal RDflag is disabled.

When the second inversion signal RDflag is enabled, the output data bus inversion unit 300 inverts the storage data DATA<0:7> and generates the second conversion data GIO_out<0:7> and the second data recovery unit 400 inverts the second conversion data GIO_out<0:7> and generates the output data DQ_out<0:7>. Conversely, when the second inversion signal RDflag is disabled, the output data bus inversion unit 300 passes through the storage data DATA<0:7> and generates the second conversion data GIO_out<0:7> and the second data recovery unit 400 passes through the second conversion data GIO_out<0:7> and generates the output data DQ_out<0:7>. Thus, the output data DQ_out<0:7> may have substantially the same levels as the storage data DATA<0:7> and the input data DQ_in<0:7>.

The semiconductor memory apparatus 1 may further include a second delay unit 700, operatively coupled to the second data recovery unit 400, for delaying the second inversion signal RDflag. The second delay unit 700 is configured to delay the second inversion signal RDflag and provide a resultant signal to the second data recovery unit 400. Since the second conversion data GIO_out<0:7> are transmitted through the data output lines RGIO<0:7>, a time interval exists from when the second inversion determination unit 310 generates the second inversion signal RDflag to when the second data recovery unit 400 performs the inversion operation. Therefore, the second delay unit 700 is provided to compensate for the time interval.

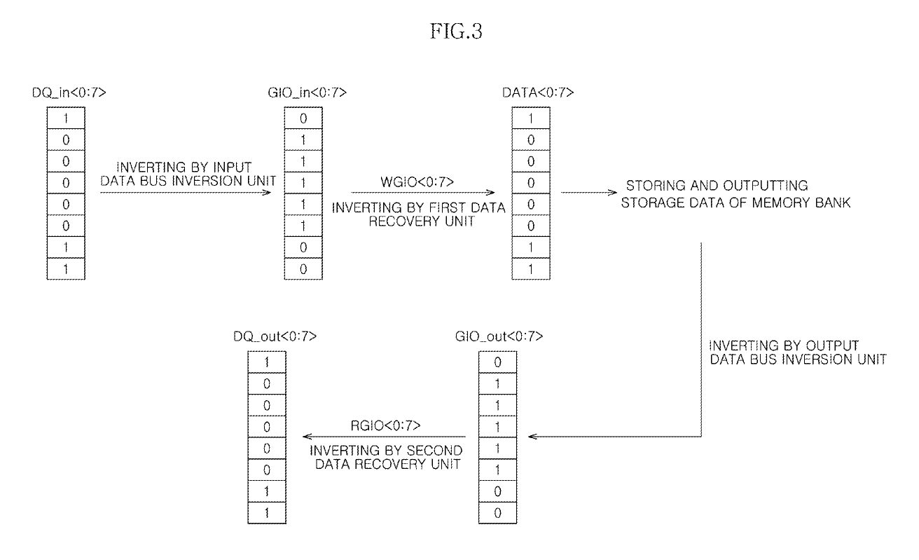

FIG. 3 is a diagram illustrating the input and output flow of data when the semiconductor memory apparatus operates in the first mode in accordance with an embodiment of the present invention.

Operations of the semiconductor memory apparatus 1 under the first operation mode in accordance with an embodiment of the present invention will be described with reference to FIGS. 2 and 3. When the data input operation of the semiconductor memory apparatus 1 is performed, the input data DQ_in<0:7> that have logic levels of ‘1, 0, 0, 0, 0, 0, 1, 1’ are inputted through the data pads. The input data bus inversion unit 100 discriminates the levels of the input data DQ_in<0:7> and determines whether or not to invert the input data DQ_in<0:7>. Since five of total eight input data DQ_in<0:7> have the first level, that is, the logic low level, the input data bus inversion unit 100 inverts the input data DQ_in<0:7> and generates the first conversion data GIO_in<0:7> that have the levels of ‘0, 1, 1, 1, 1, 1, 0, 0’. The first conversion data GIO_in<0:7> are transmitted to the first data recovery unit 200 through the data input lines WGIO<0:7>. The first data recovery unit 200 inverts the first conversion data GIO_in<0:7> and generates the storage data DATA<0:7> that have the levels of ‘1, 0, 0, 0, 0, 0, 1, 1’. The storage data DATA<0:7> are stored in the memory bank BANK.

Thereafter, when the data output operation of the semiconductor memory apparatus 1 is performed, the storage data DATA<0:7> that are stored in the memory bank BANK are outputted. The output data bus inversion unit 300 discriminates the logic levels of the storage data DATA<0:7> and determines whether or not to invert the storage data DATA<0:7>. Since five of total eight storage data DATA<0:7> have the first level, that is, the logic low level, the output data bus inversion unit 300 inverts the storage data DATA<0:7> and generates the second conversion data GIO_out<0:7> that have the levels of ‘0, 1, 1, 1, 1, 1, 0, 0’. The second conversion data GIO_out<0:7> are transmitted to the second data recovery unit 400 through the data output lines RGIO<0:7>. The second data recovery unit 400 inverts the second conversion data GIO_out<0:7> and generates the output data DQ_out<0:7> that have the levels of ‘1, 0, 0, 0, 0, 0, 1, 1’. The output data DQ_out<0:7> may be outputted to the outside of the semiconductor memory apparatus 1 through the data pads. Accordingly, the semiconductor memory apparatus 1 of the embodiments may reduce the current consumption in the data transmission lines WGIO<0:7> and RGIO<0:7> during the data input and output operations while being capable of outputting the output data DQ_out<0:7> that have substantially the same levels as the input data DQ_in<0:7>. This applies in the same manner even in the case where the input and output data bus inversion units 100 and 300 do not perform the inversion operations.

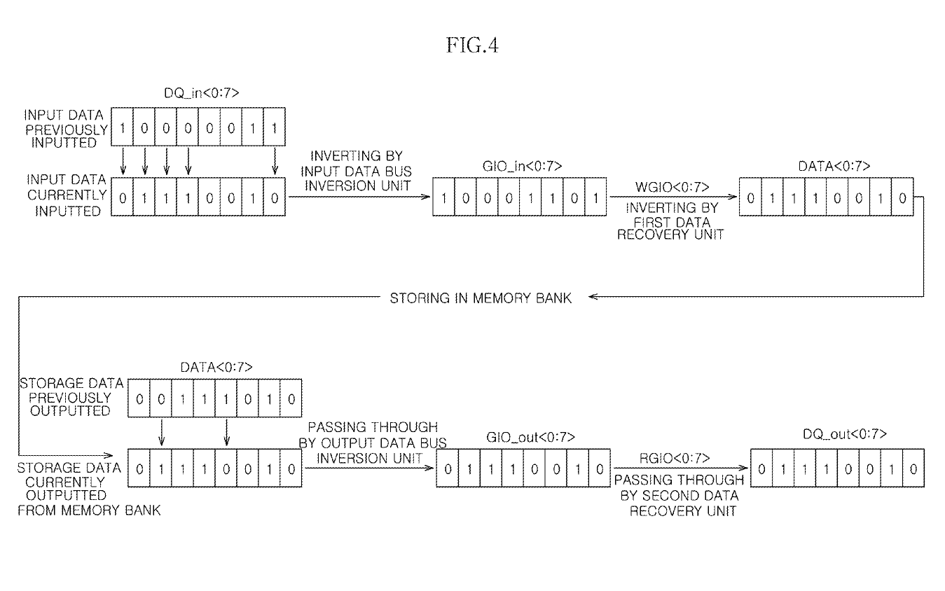

FIG. 4 is a diagram illustrating the input and output flow of data when the semiconductor memory apparatus operates in a second mode in accordance with an embodiment of the present invention.

Operations of the semiconductor memory apparatus 1 under the second operation mode in accordance with an embodiment of the present invention will be described with reference to FIGS. 2 and 4. When the data input operation of the semiconductor memory apparatus 1 is performed, the input data DQ_in<0:7> that have logic levels of ‘0, 1, 1, 1, 0, 0, 1, 0’ are inputted through the data pads. Logic levels of the input data, which are previously inputted, are ‘1, 0, 0, 0, 0, 0, 1, 1’. The input data bus inversion unit 100 compares logic levels of the plurality of input data DQ_in<0:7>, which are currently inputted, with logic levels of the plurality of input data DQ_in<0:7>, which are previously inputted, and determines whether or not to invert the input data DQ_in<0:7>, which are currently inputted. Since logic levels of five of total eight input data DQ_in<0:7>, which are currently inputted, are different from those of input data DQ_in<0:7>, which are previously inputted, the input data bus inversion unit 100 inverts the input data DQ_in<0:7> and generates the first conversion data GIO_in<0:7> that have the levels of ‘1, 0, 0, 0, 1, 1, 0, 1’. The first conversion data GIO_in<0:7> are transmitted to the first data recovery unit 200 through the data input lines WGIO<0:7>. The first data recovery unit 200 inverts the first conversion data GIO_in<0:7> and generates the storage data DATA<0:7> that have the levels of ‘0, 1, 1, 1, 0, 0, 1, 0’. The storage data DATA<0:7> are stored in the memory bank BANK.

Thereafter, when the data output operation of the semiconductor memory apparatus 1 is performed, the storage data DATA<0:7> that are stored in the memory bank BANK are outputted. Logic levels of the storage data DATA<0:7>, which are previously outputted, are ‘0, 0, 1, 1, 1, 0, 1, 0’. The output data bus inversion unit 300 compares logic levels of the plurality of storage data DATA<0:7>, which are currently outputted, with logic levels of the plurality of storage data DATA<0:7>, which are previously outputted, and determines whether or not to invert the storage data DATA<0:7>, which are currently outputted. Since two of total eight storage data DATA<0:7>, which are currently outputted, are different from those of storage data DATA<0:7>, which are previously outputted, the output data bus inversion unit 300 does not invert the storage data DATA<0:7>, which are currently outputted, and generates the second conversion data GIO_out<0:7> that have the levels of ‘0, 1, 1, 1, 0, 0, 1, 0’. The second conversion data GIO_out<0:7> are transmitted to the second data recovery unit 400 through the data output lines RGIO<0:7>. The second data recovery unit 400 passes through the second conversion data GIO_out<0:7> and generates the output data DQ_out<0:7> that have the levels of ‘0, 1, 1, 1, 0, 0, 1, 0’. The output data DQ_out<0:7> may be outputted to the outside of the semiconductor memory apparatus 1 through the data pads.

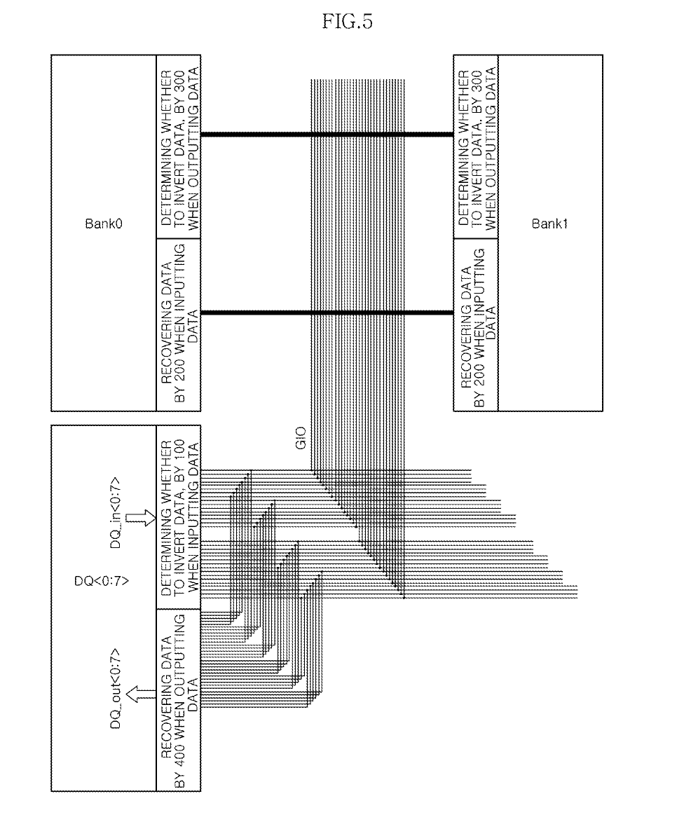

FIG. 5 is a diagram schematically illustrating the layout of the semiconductor memory apparatus 1 in accordance with an embodiment of the present invention.

Referring to FIG. 5, data pads DQ<0:7> are disposed in a peripheral region between first and second memory banks BANK0 and BANK1. When inputting data, if the input data DQ_in<0:7> are inputted through the data pads DQ<0:7> from the outside of the semiconductor memory apparatus 1, the input data DQ_in<0:7> are outputted to the data transmission lines GIO by being inverted or passed through by the input data bus inversion unit 100. As aforementioned above, since the data input lines WGIO<0:7> and the data output lines RGIO<0:7> constitute the same data transmission lines, the data input lines WGIO<0:7> and the data output lines RGIO<0:7> are shown as the data transmission lines GIO in FIG. 5. The input data bus inversion unit 100 may be disposed adjacent to the data pads DQ<0:7>. This is because current consumption that is likely to occur in the data transmission lines GIO may be reduced when whether or not to invert the input data DQ_in<0:7> is determined depending upon the logic levels of the input data DQ_in<0:7> and resultant data are transmitted to the data transmission lines GIO as soon as the plurality of input data DQ_in<0:7> are inputted through the data pads DQ<0:7>.

The first data recovery unit 200 is disposed adjacent to the memory banks BANK0 and BANK1. The first data recovery unit 200 transmits the data transmitted through the data transmission lines GIO to the memory banks BANK0 and BANK1 by inverting or passing through the data. Accordingly, the first data recovery unit 200 ensures that the data that have substantially the same levels as the input data DQ_in<0:7> may be stored in the memory banks BANK0 and BANK1.

When outputting data, the output data bus inversion unit 300 inverts or passes through the data outputted from the memory banks BANK0 and BANK1 and transmits resultant data to the data transmission lines GIO. The output data bus inversion unit 300 may be disposed adjacent to the first and second memory banks BANK0 and BANK1. Also, specifically, if the data stored in the first and second memory banks BANK0 and BANK1 are loaded on the data transmission lines GIO after being collected in a cross area, the output data bus inversion unit 300 may be disposed in the cross area. The cross area indicates a zone where regions, in which the row-related control circuits and column-related control circuits of the semiconductor memory apparatus are positioned, cross with each other. This is because current consumption that is likely to occur in the data transmission lines GIO may be reduced when whether or not to invert the data outputted from the memory banks BANK0 and BANK1 is determined depending upon the logic levels of the data and resultant data are transmitted to the data transmission lines GIO as soon as the data are inputted to the output data bus inversion unit 300.

The second data recovery unit 400 is disposed adjacent to the data pads DQ<0:7>. The second data recovery unit 400 transmits the data transmitted through the data transmission lines GIO to the data pads DQ<0:7> by inverting or passing through the data. Accordingly, the second data recovery unit 400 may output the output data DQ_out<0:7> that have substantially the same levels as the data outputted from the memory banks BANK0 and BANK1, to the data pads DQ<0:7>. The data pads DQ<0:7> output the output data DQ_out<0:7> outputted from the second data recovery unit 400, to the outside of the semiconductor memory apparatus 1. As a result, the semiconductor memory apparatus 1 of the embodiments may reduce the current consumption of the data transmission lines by inverting or passing through the levels of the input data while storing the data having the same levels as the input data in the memory banks. Moreover, the semiconductor memory apparatus 1 of the embodiments may reduce the current consumption of the data transmission lines by inverting or passing through the levels of the data stored in the memory banks while outputting the data having the same levels as the data stored in the memory banks, through the data pads.

While certain embodiments have been described above, it will be understood to those skilled in the art that the embodiments described are by way of example only. Accordingly, the semiconductor memory apparatus and the data input and output method thereof described herein should not be limited based on the described embodiments. Rather, the semiconductor memory apparatus and the data input and output method thereof described herein should only be limited in light of the claims that follow when taken in conjunction with the above description and accompanying drawings.

What is claimed is:

1. A semiconductor memory apparatus comprising:
an input data bus inversion unit configured to determine whether or not to invert a plurality of input data based on an operation mode signal and the plurality of input data and to generate a plurality of conversion data;
a data input line configured to transmit the plurality of conversion data;
a termination unit configured to terminate the data input line in response to the operation mode signal;
a data recovery unit configured to receive the plurality of conversion data and generate a plurality of storage data; and
a memory bank configured to store the plurality of storage data.

2. The semiconductor memory apparatus according to claim 1, wherein the input data bus inversion unit comprises:
an inversion determination unit configured to discriminate levels of the plurality of input data in response to the operation mode signal and generate an inversion signal; and
a data conversion unit configured to invert or pass through the plurality of input data in response to the inversion signal and generate the plurality of conversion data.

3. The semiconductor memory apparatus according to claim 2, wherein the inversion determination unit is configured to enable the inversion signal in response to a first operation mode signal when a majority of the plurality of input data have a first level.

4. The semiconductor memory apparatus according to claim 3, wherein the termination unit is configured to terminate the data input line to a second level in response to the first operation mode signal.

5. The semiconductor memory apparatus according to claim 2, wherein the inversion determination unit is configured to enable the inversion signal in response to a second operation mode signal when a majority of logic levels of the plurality of input data, which are currently inputted, are different from logic levels of the plurality of input data, which are previously inputted.

6. The semiconductor memory apparatus according to claim 5, wherein the termination unit is configured not to terminate the data input line in response to the second operation mode signal.

7. The semiconductor memory apparatus according to claim 2, wherein the data recovery unit is configured to receive the plurality of conversion data to generate the plurality of storage data having substantially the same logic levels as the plurality of input data in response to the inversion signal.

8. The semiconductor memory apparatus according to claim 1, wherein the data input line is configured to connect the input data bus inversion unit and the memory bank, and
wherein the input data bus inversion unit is configured to be connected to a data pad.

9. A semiconductor memory apparatus comprising:
an input data bus inversion unit configured to determine whether or not to invert a plurality of input data based on an operation mode signal and the plurality of input data and to generate a plurality of first conversion data;
a first data recovery unit configured to invert or pass through the plurality of first conversion data and generate a plurality of storage data;
a memory bank configured to store the plurality of storage data;
an output data bus inversion unit configured to determine whether or not to invert the plurality of storage data outputted from the memory bank based on the operation mode signal and the plurality of storage data outputted from the memory bank and to generate a plurality of second conversion data;
a second data recovery unit configured to receive the plurality of second conversion data and generate a plurality of output data; and
a data transmission line configured to transmit the plurality of first conversion data and the plurality of second conversion data.

10. The semiconductor memory apparatus according to claim 9, wherein the input data bus inversion unit comprises:
a first inversion determination unit configured to discriminate levels of the plurality of input data in response to the operation mode signal and generate a first inversion signal; and
a first data conversion unit configured to invert or pass through the plurality of input data in response to the first inversion signal and generate the plurality of first conversion data.

11. The semiconductor memory apparatus according to claim 10, wherein the first inversion determination unit is configured to enable the first inversion signal in response to a first operation mode signal when a majority of the plurality of input data have a first level.

12. The semiconductor memory apparatus according to claim 11, further comprising a termination unit configured to terminate the data transmission line to a second level in response to the first operation mode signal.

13. The semiconductor memory apparatus according to claim 10, wherein the first inversion determination unit is configured to enable the first inversion signal in response to a second operation mode signal when a majority of logic levels of the plurality of input data, which are currently inputted, are different from logic levels of the plurality of input data, which are previously inputted.

14. The semiconductor memory apparatus according to claim 10, further comprising a first delay unit configured to delay and provide the first inversion signal to the first data recovery unit.

15. The semiconductor memory apparatus according to claim 9, wherein the output data bus inversion unit comprises:
a second inversion determination unit configured to discriminate logic levels of the plurality of storage data in response to the operation mode signal and generate a second inversion signal; and
a second data conversion unit configured to invert or pass through the plurality of storage data in response to the second inversion signal and generate the plurality of second conversion data.

16. The semiconductor memory apparatus according to claim 15, wherein the second inversion determination unit is configured to enable the second inversion signal in response to a first operation mode signal when a majority of the plurality of input data have a first level.

17. The semiconductor memory apparatus according to claim 16, further comprising a termination unit configured to terminate the data transmission line to a second level in response to the first operation mode signal.

18. The semiconductor memory apparatus according to claim 15, wherein the second inversion determination unit is configured to enable the second inversion signal in response to a second operation mode signal when a majority of logic levels of the plurality of storage data, which are currently outputted, are different from logic levels of the plurality of storage data, which are previously outputted.

19. The semiconductor memory apparatus according to claim 10, further comprising a second delay unit configured to delay and provide the second inversion signal to the second data recovery unit.

20. A semiconductor memory apparatus comprising:
an data bus inversion unit configured to determine whether or not to invert a plurality of received data based on an operation mode signal and the plurality of received data and to generate a plurality of conversion data;
a data transmission line configured to transmit the plurality of conversion data; and
a termination unit configured to terminate the data transmission line in response to the operation mode signal.
